(19) United States
(12) Patent Application Publication
(10) Pub. No.: US 2007/0219837 A1
(43) Pub. Date: Sep. 20, 2007

(54) Method and structure for risk-based workforce management and planning

(75) Inventors: Yingdong Lu, Yorktown Heights, NY (US); Ana Radovanovic, New York, NY (US); Mark S. Squillante, Pound Ridge, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/375,001

(22) Filed: Mar. 15, 2006

(51) Int. Cl. G05B 19/418

(52) U.S. Cl. 705/8

(57) ABSTRACT

A method of managing resources, includes identifying a project or service opportunity that has disparate resource attribute requirements. At least one of internal and external flexible resources suitable for the project or service opportunities are also identified. The internal and external flexible resources are correlated with the disparate resource attribute requirements for managing a risk associated with the project or service opportunity.

### BACKGROUND OF THE INVENTION

1. Field of the Invention

The present invention generally relates to management and planning in any entity that maintains and operates a collection of resources in general. More particularly, modeling, analysis, optimization, management, and planning of resources is provided in a computerized tool to best achieve economic and business strategy objectives in the presence of uncertainty. In an exemplary embodiment, the method is used for workforce management, including human resources and other flexible resources.

2. Description of the Related Art

The management and planning of its workforce are significant drivers of profitability for many businesses, especially those with a large number of employees and high demands. The projects or services performed by a business require different capabilities, skills and experience for various tasks and phases of the project or service. With the increased use of contractors, subcontractors, outsourcing and other non-traditional approaches for obtaining resources, the pool of resources and various options available to staff the tasks and phases of a project or service have increased in magnitude and complexity.

If human or other flexible resources with the appropriate requirements and attributes are not available as part of a project or service, either newly started or ongoing, then the business can suffer significant economic and strategic losses. This includes, but is not limited to, increased costs, lost revenue, loss of the entire project or service, loss of tasks or phases of a project or service, lost market share, and so on.

There are many sources of uncertainty in the management and planning of a workforce. This includes, but is not limited to, uncertainty in demand, supply, duration of projects or services, duration of tasks or phases of a project or service, lead times for acquiring or retraining resources with desired capabilities, skills and experience, and so on. Such uncertainties increase the exposure of a business to inefficiencies, slow and/or limit innovation, ineffectiveness, problems with project or service quality, risk of economic losses, risk of lost opportunities, risk of strategic losses, and the like.

Various current business trends, including trends toward smaller time scales for business operations, responsiveness, resilience, agility and so on, are significantly increasing the complexity of workforce management and planning, the impact of workforce management and planning on achieving economic and business strategy objectives, and the many sources and magnitude of uncertainty in workforce management and planning. The problem complexity and impact on a business significantly increases with its number of resources, the diversity and flexibility of its resources, the demand for its projects or services, the diversity of its projects or services, and the various constraints on its resources, projects and services.

The present invention recognizes the need for and the problems arising from an integrated risk-based approach to the management and planning of a workforce in the presence of various sources and forms of uncertainty and also provides a solution to such problems.

### SUMMARY OF THE INVENTION

In view of the foregoing, and other, exemplary problems, drawbacks, and disadvantages of the conventional systems, it is an exemplary feature of the present invention to provide a structure (and method) for improving business profitability through efficient and effective risk-based workforce management and planning.

It is another exemplary feature of the present invention to provide a method and apparatus for managing and planning of resource capacity levels in the presence of various sources of uncertainty.

It is another exemplary feature of the present invention to provide a method and apparatus for managing and planning of resource actions and decisions over time in the presence of various sources of uncertainty.

It is, therefore, an exemplary object of the present invention to provide a structure and method for a risk-based approach that captures uncertainty in workforce management and planning models, analysis, and optimization.

It is another exemplary object of the present invention to provide a structure and method for modeling, analyzing, and optimizing workforce capacity levels to minimize costs and maximize profits, while satisfying tolerances on various business risks.

It is another exemplary object of the present invention to provide a structure and method for managing and planning of resource actions and decisions over time by modeling uncertainty in demand, supply, project requirements, lead times, etc.

To achieve the above exemplary purposes, features, and aspects, in a first exemplary aspect of the present invention, described herein is a method of managing resources, including identifying a project or service opportunity, that comprises disparate resource attribute requirements and identifying at least one of internal and external flexible resources suitable for the project or service opportunities. The internal and external flexible resources are then correlated with the disparate resource attribute requirements for managing a risk associated with the project or service opportunity.

In a second exemplary aspect of the present invention, also described herein is a method of managing a collection of resources, including calculating a stochastic model of a demand and calculating a stochastic model of a supply of resource to meet the demand, and a signal-bearing medium tangibly embodying a program of machine-readable instructions executable by a digital processing apparatus to perform that method.

Therefore, the present invention provides a quantitative tool for use in scenarios in which resources can be simultaneously working on multiple projects or services employing any combination of capabilities, skills, or experience. The risk-based models and optimization for each component of the present invention support interactive what-if, sensitivity, and scenario analysis with respect to all elements of the models and solutions, including assumptions and parameters, and provides the basis for conducting business in accordance thereto.

### BRIEF DESCRIPTION OF THE DRAWINGS

The foregoing and other objects, aspects and advantages will be better understood from the following detailed description of preferred embodiments of the invention with reference to the drawings, in which:

FIG. 1 shows a time horizon diagram 100 exemplarily describing the concept of workforce probabilistic decision optimization over a periodic basis, such as weekly;

FIG. 2 shows a time horizon diagram 200 exemplarily demonstrating the concept of how workforce resource gaps 201 and gluts 202 result from a dynamic environment that requires appropriate timing of workforce decisions;

FIG. 3 shows an overview 300 of workforce probabilistic modeling and optimization, as described in an exemplary embodiment of the present invention;

FIG. 4 is a representation 400 of the components of an exemplary embodiment the present invention, along with their interactions;

FIG. 5 is an exemplary representation 500 of mode I of the Demand Capacity Plan component 401;

FIG. 6 is an exemplary representation 600 of mode II of the Demand Capacity Plan component 401;

FIG. 7 is an exemplary representation 700 of the Supply Capacity Plan component 402;

FIG. 8 is an exemplary representation 800 of the Multi-Attribute Gap/Glut Analysis component 403;

FIG. 9 is an exemplary representation of the Planning Action Support component 404 and its interactions with other components of the present invention, as providing outputs at specific time intervals;

FIG. 10 shows an exemplary Project Service Selection function 1000 of an embodiment of the present invention;

FIG. 11 illustrates an exemplary hardware/information handling system 1100 for incorporating the present invention therein; and

FIG. 12 illustrates a signal bearing medium 1200 (e.g., storage medium) for storing steps of a program of a method according to the present invention.

### DETAILED DESCRIPTION OF AN EXEMPLARY EMBODIMENT OF THE INVENTION

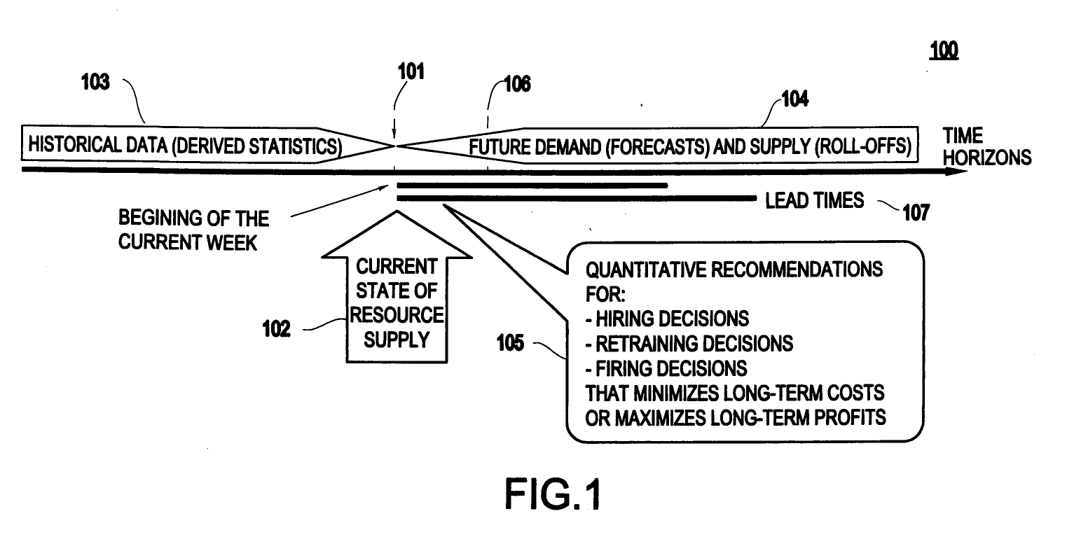

Referring now to the drawings, and more particularly to FIGS. 1-12, an exemplary embodiment of the present invention will now be described.

In this exemplary embodiment, the present invention provides a method and apparatus for workforce management and planning in the presence of uncertainty. It is based on a risk-based approach that captures various sources and types of uncertainty and their interactions, such as the variability and correlations in different aspects of workforce management and planning, in order to model, analyze, and optimize resource capacity levels, resource planning decisions and actions, and general workforce management, to best achieve economic and business strategy objectives.

FIG. 1 provides an exemplary optimization scenario 100 on a periodic (e.g., weekly) basis that demonstrates the problem of workforce optimization being addressed by this exemplary embodiment. At any present time 101, such as the beginning of a current week, there is a current state of resource supply 102. Typically, there will also be historical data 103 from which statistics on the workforce resources can be derived, including historical data provided as outputs by various modules of the present invention for previous time period(s), perhaps as corrected by user inputs. Since management has the task of meeting future demand 104 for the workforce, a number of workforce decisions 105 are routinely made within the period (e.g., weekly, monthly, etc.) 106, including hiring, retraining, and firing decisions, preferably in a manner that accommodates the various lead times 107 for the various planning actions based on the foreseeable future of supply and demand.

The present invention models the complex interactions between the variability and correlation in demand for resource capabilities, skills, and experience and in supply for available resources with these capabilities, skills, and experience, using probabilistic methods and optimization methods. The uncertainties present in both the demand and supply processes include, but are not limited to, such factors as variability and correlation in the arrivals of projects or services, the duration of projects or services, the capability, skill or experience requirements for the projects or services, the duration of tasks or phases of a project or service, the capability, skill, or experience requirements for tasks or phases of a project or service, and so on.

Risk-based models are used to capture this probabilistic and dynamic behavior and to analyze the various business risks associated with specific resource staffing levels and the ability to achieve key business indicators and performance targets under these staffing levels. Risk-based optimization is used together with these risk-based models to determine the optimal resource staffing levels and general workforce management over a given time horizon in terms of economic and business strategy objective, while achieving key business indicators and performance targets.

The methods and apparatus of the present invention are not limited to any specific time horizon or range of time horizons and, thus, apply generally to any period of time of interest. This includes optimization subject to constraint tolerances on the various business risks.

The present invention also models the complex interactions between the variability and correlation in demand and supply over multiple consecutive time periods using probabilistic methods and optimization methods. Such uncertainties include, but are not limited to, longer-term variability and correlation in the above demand and supply processes, the lead times for acquiring resources with the desired capability, skill, or experience, the lead times for retraining resources to have the desired capability, skill, or experience, the lead times for contracting, subcontracting, outsourcing, or other non-traditional resource options, the lead times for other workforce management and planning decisions and actions, and so on.

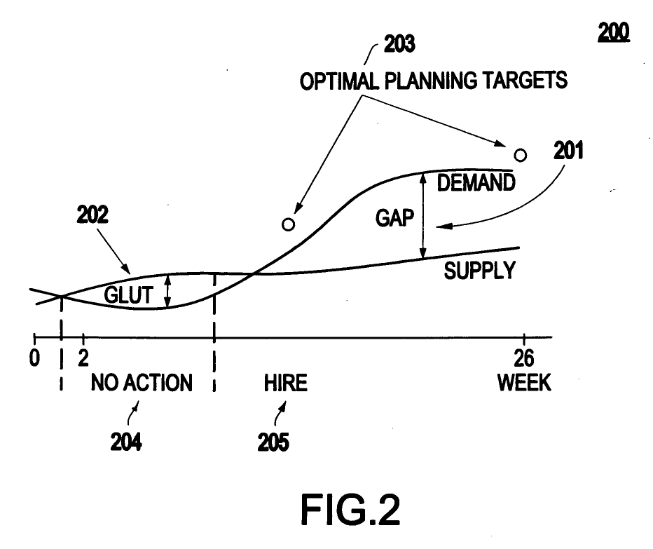

Thus, as exemplarily illustrated in FIG. 2, the risk-based models are used to capture this probabilistic and dynamic behavior 200 and to analyze the various business risks associated with specific resource staffing levels over time, the levels of shortages (gaps) 201 or excesses (gluts) 202 in resource capabilities, skills or experience, and the ability to achieve key business indicators and performance targets 203 under these staffing levels over time. In the scenario of FIG. 2, a workforce resource glut 202 is predicted in the short term, but hiring would have to be executed in the foreseeable future in order to provide sufficient workforce resources for an anticipated gap 201. The tool provided by the present invention allows managers to foresee such gaps 201 and gluts 202 and make workforce decisions 204, 205 as appropriate and in a timely manner.

Risk-based optimization is used together with these risk-based models to determine the optimal workforce management and planning decisions and actions, such as acquiring resources, retraining resources, retaining resources, borrowing resources, various forms of outsourcing, and accepting or rejecting projects or services, over multiple consecutive time periods in terms of economic and business strategy objectives while achieving key business indicators and performance targets. This includes optimization subject to constraints on the various business risks and on the various workforce management and planning decisions and actions.

The models and optimization of the present invention consider existing resource capabilities, skills and experience, potential resource capabilities, skills and experience, flexibility in resource capabilities, skills and experience, other forms of flexibility of resources, locations of resources, economic factors associated with demand, economic factors associated with supply, business strategy requirements and policies, market opportunities, and so on. These resource attributes are provided merely as an example and are not intended to limit the invention to only these attributes. One knowledgeable in the art would recognize that numerous other attributes could be used.

In addition, the present invention includes the ability to prefer one attribute or set of attributes as the first choice but allow for flexibility such as employing other attributes or sets of attributes as second choices if the first choice is not available or is reserved elsewhere due to uncertainty and other business factors. The same goes for third choices, and so on. The management and planning of resources for the projects or services of a business must capture these effects and their impact on achieving the economic and strategic objectives of a business.

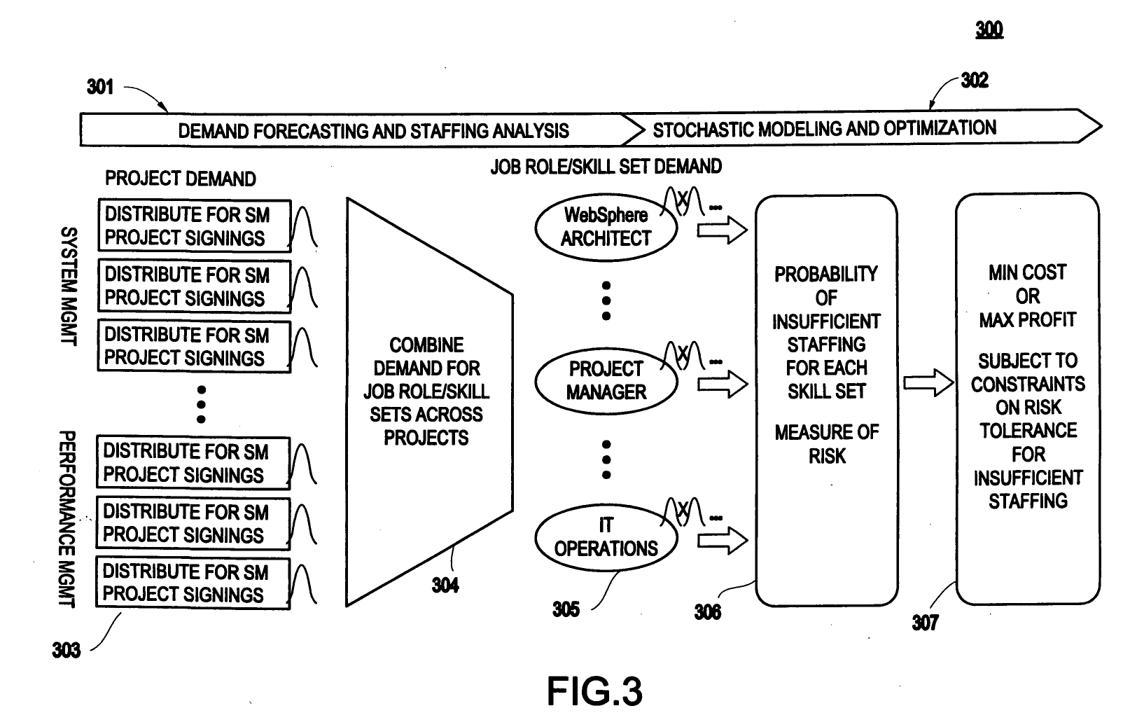

FIG. 3 shows an overview 300 of how workforce probabilistic modeling and optimization is implemented in an exemplary embodiment of the present invention, including a first stage 301 of forecasting demand and analyzing staffing requirements and a subsequent stage 302 of developing stochastic modeling that is then solved for an optimum.

In the initial stage 301, project demand data is obtained 303 by such means as data derived from entry of new projects currently being planned, along with any historical data for ongoing or previously-planned projects. From this data, the tool will derive a workforce demand 304 across all of the projects, including specific skills such as, for example, specific web programming, managerial, and operations expertise 305.

In the second stage 302, the stochastic modeling provides a mechanism to develop probabilities and risks for each skill set 306 and an optimum solution 307 for the demand, subject to constraints for risk of insufficient staffing.

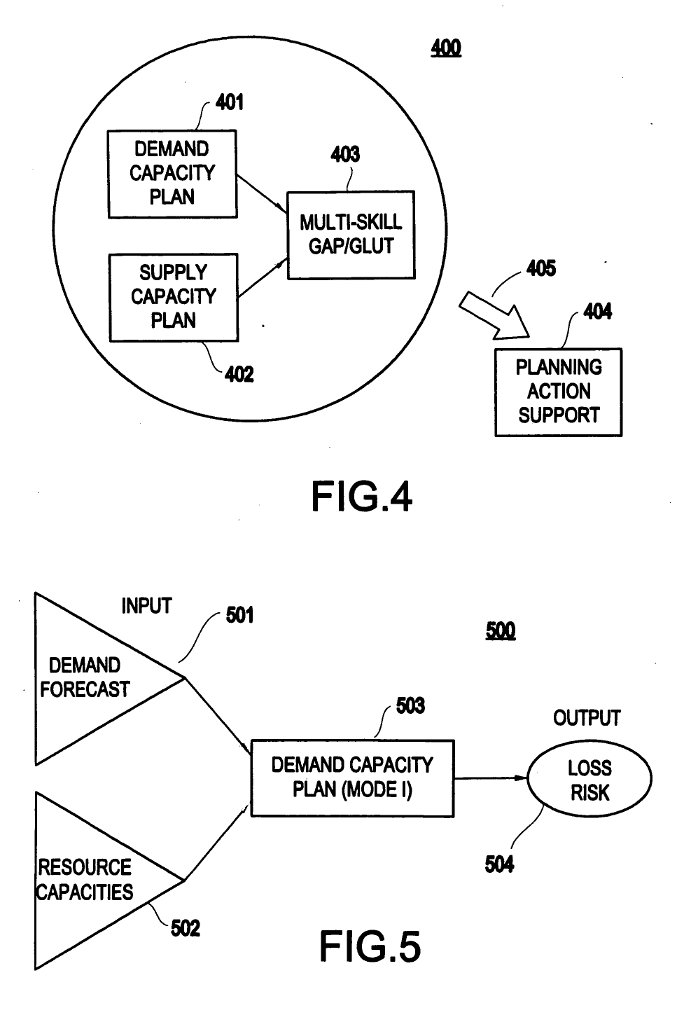

As can be seen in FIG. 4, an exemplary embodiment 400 of the present invention includes several components and their combination to address the various aspects of workforce management and planning in the presence of uncertainty. These components focus on different levels and time-scales for the overall workforce management and planning process.

The exemplary four components are a Demand Capacity Plan module 401, a Supply Capacity Plan module 402, a Multi-attribute gap/glut module 403, and a Planning Action Support module 404. The Demand Capacity Plan and the Supply Capacity Plan modules 401, 402 provide inputs to Multi-attribute gap/glut module 403, which then altogether represent the input 405 to the Planning Action Support module 404.

FIG. 5 shows the operation 500 in Mode I of Demand Capacity Plan module 401. The inputs to this module are demand forecast 501 and resource capacities 502, and the Demand Capacity Plan Mode I module 503 produces loss risk 504. The demand forecast input 501 characterizes the types of uncertainty in demand as explained above. The resource capacities input 502 specifies the capacity levels for different resource types to be used in the analysis. The different types of controls available to the user of Mode I of this module include, but are not limited to, adjustments in the demand forecast and resource capacities.

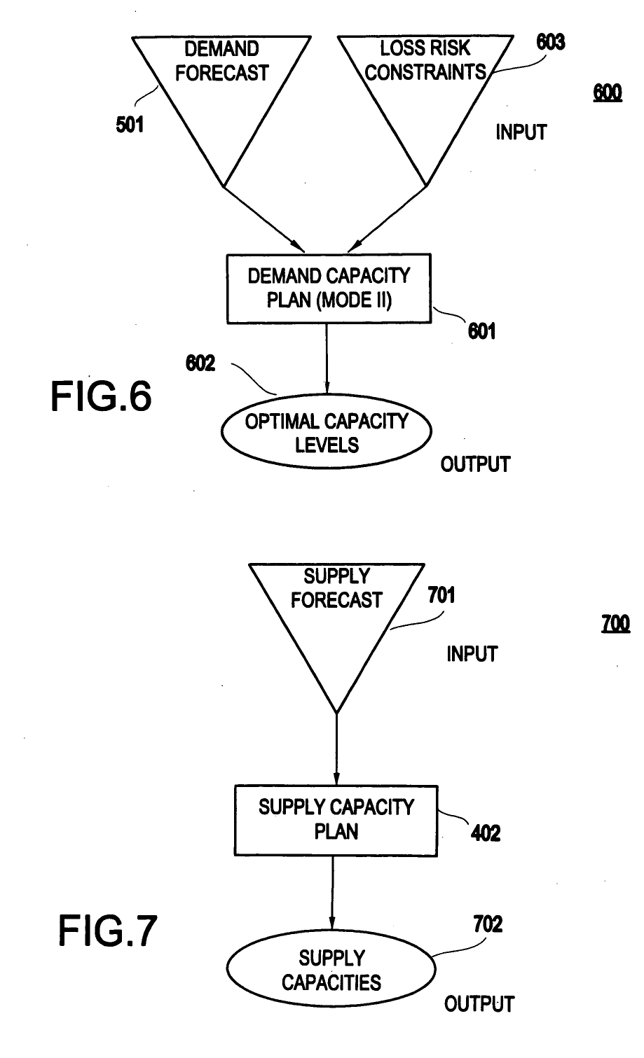

FIG. 6 shows the operation 600 in Mode II of the Demand Capacity Plan module 401, having as inputs the demand forecast 501 and loss risk constraints 603. The Demand Capacity Plan Mode II module 601 produces optimal capacity levels 602 and loss risks 604 as output. The demand forecast 501 input characterizes the types of uncertainty in demand as explained above. The loss risk 603 input specifies constraints that the optimal solution must satisfy as part of the analysis. The different types of controls available to the user of Mode II of this module include, but are not limited to, adjustments in the demand forecast 501 and loss risk 603 constraints.

It is noted that the loss risk constraints 603 are not inputs from Mode I, since Mode I and Mode II are different uses of the Demand Capacity Plan.

FIG. 7 shows the operation 700 of the Supply Capacity Plan module 402, receiving as input the supply forecast 701 and producing supply capacities 702 as an output. The supply forecast 701 input characterizes the types of uncertainty in resource supply as explained above. The different types of control available to the users of this module include, but are not limited to, adjustments in the supply forecast such as attrition behavior.

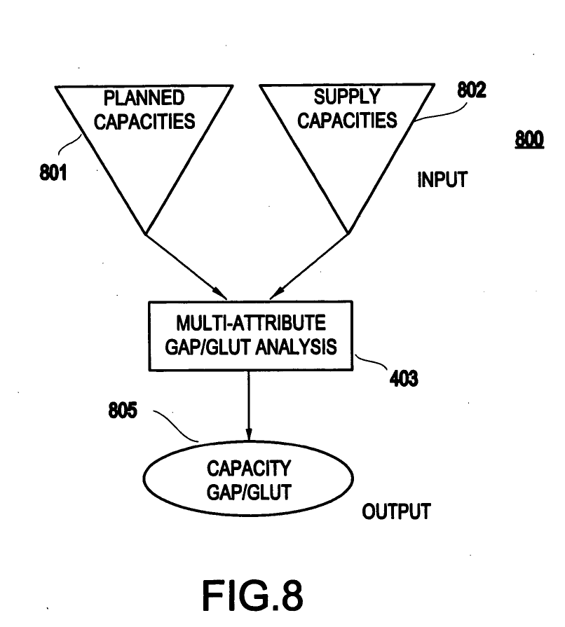

FIG. 8 shows the operation 800 of the Multi-attribute gap/glut module 403, receiving as inputs planned capacities 801 and supply capacities 802 and providing as output a capacity gap/glut 803. The planned capacities input 801, which could include outputs 602 shown in FIG. 6, characterizes the resource capacity requirements from the demand perspective, whereas the supply capacities 802 input, which could include outputs 702 shown in FIG. 7, characterizes the resource capacity availability from the supply perspective. The different types of controls available to the user for this module include, but are not limited to, adjustments in the weights (such as costs, revenues, priorities, preferences, experience, etc.) for the gaps and gluts of each skill.

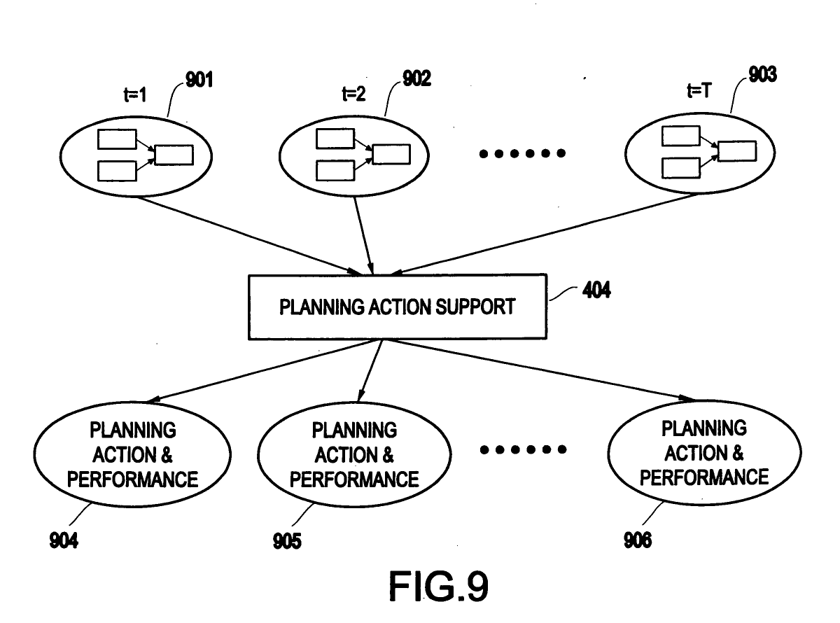

FIG. 9 shows the operation 900 of Planning Action Support module 404, receiving as inputs the results of Demand Capacity Plan, Supply Capacity Plan and Multi-attribute gap/glut analysis at multiple consecutive planning time periods, 901, 902, . . . , 903, and producing planning actions and performance 904, 905, 906 for each time point t=1, t=2, . . . t=T. The inputs and outputs are as described above for the corresponding modules. The different types of controls available to the user of this module include, but are not limited to, the financial and strategic impact of actions taken.

It is noted that the upper portion of FIG. 9 shows components of FIG. 4 as replicated at various time points t=1, 2, . . . T. Therefore, FIG. 9 also demonstrates the periodic aspect of this embodiment of the present invention, as well as demonstrating how the present invention is capable of providing historical data for future time period calculations.

Returning now to FIG. 5, the Demand Capacity Plan Mode I module 503 receives input data related to a demand forecast 501 and resource capacities 502. These inputs might include, but is not necessarily limited to, a characterization of such factors as:
the arrivals of each type of project or service;
the duration of each type of project or service;
the capability, skill, experience and other staffing requirements for each type of project or service;
the duration of tasks or phases for each type of project or service; and
the capability, skill, experience and other staffing requirements for tasks or phases of each type of project or service, etc.

The exemplary embodiment considers these characterizations to include the variability, correlation and other aspects of the uncertainty involved with this demand forecast information. One exemplary embodiment consists of characterizing uncertainty through a few moments (e.g., mean and variance) for the input data, whereas other exemplary embodiments consist of providing distributions and correlations for such input data as well as correlation between different inputs.

The present invention then takes this input to provide two modes of operation. First, as exemplarily shown in FIG. 5, given the demand forecast 501 and a set 502 of resource capacities for each capability, skill, and experience, Mode I of the Demand Capacity Plan 503 determines the probability that an arriving project or service finds insufficient resources available in one or more capability, skill, or experience levels, either immediately at the instant of arrival or within some bounded interval since the arrival. These probabilities provide a measure of risk 504, in the sense that such projects or services are at risk for being lost or cancelled, and thus shall be henceforth called loss risk probabilities. These risk probabilities also can be used to provide confidence levels on losses of projects or services.

Subsequently, as exemplarily shown in FIG. 6, given the demand forecast, a set of loss risk probability constraints for each type of project or service (allowing for the absence of such constraints) and any other constraints, the Mode II module 601 of the Demand Capacity Planning module 401 determines the optimal set of resource capacities 602 for each capability, skill, and experience, while ensuring that all loss risk probabilities and other constraints are satisfied. The objective of the optimization can be any function of economic losses and gains, strategic losses and gains, project or service quality, business effectiveness, business efficiency, innovation, business opportunities, and so on. Thus, as demonstrated by this figure, in this exemplary embodiment, the present invention serves as a basis in a method of operating a business, service, etc.

The Supply Capacity Plan module 402 is shown in more detail in FIG. 7. A supply forecast 701 is provided as input. This could include, but is not limited to, a characterization of the collection of capabilities, skills and experience in the current workforce, a characterization of future losses (e.g., attrition, firing) for each collection of capabilities, skills and experience, a characterization of future changes in the collection of capabilities, skills and experience in existing workforce resources, a characterization of future additions (e.g., hiring) for each collection of capabilities, skills and experience, a characterization of future promotions and transfers, and so on.

An exemplary embodiment considers these characterizations to include the variability, correlation and other aspects of the uncertainty involved with this supply forecast information. The present invention then takes this input to construct a risk-based model of the probabilistic and dynamic behavior of the multiple capability, skill and experience workforce supply resources. This includes the uncertainty in an existing resource assignment and its completion of this role to become available for another project or service.

The Multi-Attribute Gap and Glut Analysis module 403 is exemplarily shown in FIG. 8, wherein the above Demand Capacity Plan and Supply Capacity Plan are provided as inputs 801, 802.

In particular, given the resource capacity levels for each capability, skill and experience from the Demand Capacity Plan 401 and given the resource capacity levels for each combination of capabilities, skills and experiences from the Supply Capacity Plan 402, the present invention first determines the optimal planning assignment of multiple capability/skill/experience supply resources to the resource demand for each capability/skill/experience and then determines the levels of shortages (gaps) or excesses (gluts) in resource capabilities, skills or experience under this optimal assignment. The objective of the optimization includes individual weights for the gaps and the gluts for each capability, skill or experience, where the weights can reflect measure of economic losses and gains, strategic losses and gains, project or service quality, business effectiveness, business efficiency, innovation, business opportunities, priorities, preferences, and so on.

An important aspect of this method is the need to capture the multiple capabilities, skill and experience of supply resources and the probabilistic characteristics of the demand capacity and supply capacity plans that capture the foregoing uncertainties in demand and supply. The Multi-Attribute Gap and Glut Analysis can be either for a single planning time period or over multiple consecutive planning time periods.

It may often be the case that the optimal Demand Capacity Plan consists of non-zero loss risk probabilities for one or more types of projects or services, as economic and strategic factors make a zero loss risk probability prohibitive. In such cases, some fraction of projects or services of each type will be lost or cancelled due to insufficient resources available in one or more capability, skill or experience levels, either immediately at the instant of the project or service arrival or within some bounded interval since the arrival.

The Planning Action Support module 404 is exemplarily shown in FIG. 9, wherein the above Demand Capacity Plan, Supply Capacity Plan and Multi-Attribute Gap and Glut Analysis are provided as inputs for successive time intervals 901, 902, 903.

The Planning Action Support module 404 then addresses workforce management and planning decisions and actions over corresponding multiple consecutive planning time periods 904-906. This includes longer-term variability and correlation in the demand and supply processes, the lead times for acquiring resources with the desired capability, skill or experience, the lead times for retraining resources to have the desired capability, skill or experience, the lead times for contracting, subcontracting, outsourcing or other non-traditional resource options, the lead times for planning decisions and actions, and the like. The inputs and outputs are as described above for the corresponding modules, since the inputs 901-903 are symbolically represented as specific instantiations of a portion of the interface shown in FIG. 4. The different types of controls available to the user of this module include, but are not limited to, the financial and strategic impact of actions taken.

The workforce management and planning decisions and actions include, but are not limited to, hiring resources with certain capabilities, skills or experience, acquiring such resources by other means, retaining resources with certain capabilities, skills or experience, retraining resources to have certain capabilities, skills or experience, borrowing resources with certain capabilities, skills or experience, firing resources with certain capabilities, skills or experience, releasing such resources by other means, various forms of outsourcing. Given forecasts for the demand and supply over the multiple planning time periods and given the various aspects and results of the Demand Capacity Plan, Supply Capacity Plan and Multi-Attribute Gap and Glut Analysis for each of these time periods, the present invention determines the optimal set of workforce management and planning decisions and actions at points in time while ensuring any constraints are satisfied. Risk-based models and optimization are used to capture the probabilistic and dynamic behavior over this longer time horizon.

The points in time at which decisions and actions are made can either be provided as input to the risk-based models and optimization or they can be determined by the risk-based models and optimization.

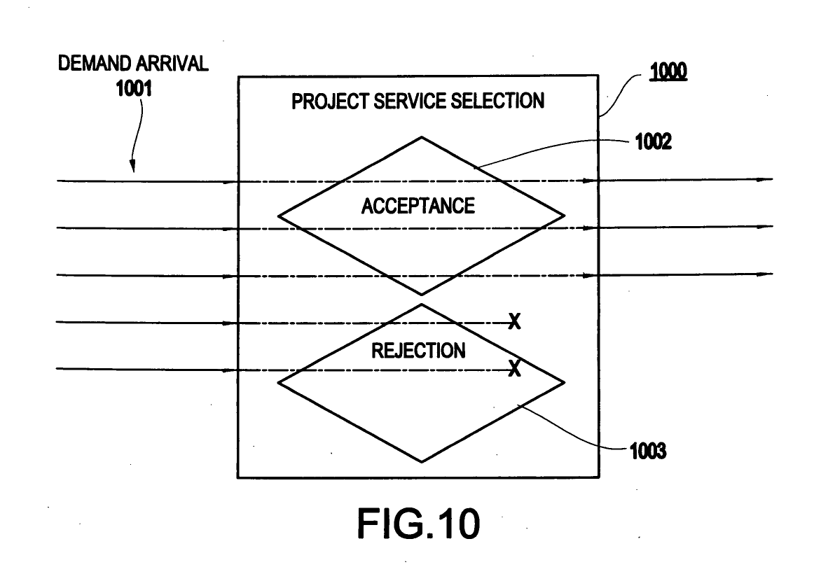

The Planning Action Support module considers the future time horizon. In contrast, the Project Service Selection function 1000 considers current and near-term decisions for arriving projects or services. The Project and Service Selection function 1000 is exemplarily shown in FIG. 10 and has the function to determine which projects and services 1001 should be accepted 1002 and which should be rejected 1003 as part of the non-zero loss risk probability from the optimal Demand Capacity Plan. Risk-based models and optimization are used to obtain a control policy for project or service selection and rejection, where the control policy is often dependent upon the state of the workforce and business environment. When a bounded interval is provided within which projects or services must be selected or rejected, the present invention determines the optimal selection and rejection of projects or services available within this interval, while taking into account the long-run loss risk probabilities from the Demand Capacity Plan and the probabilistic characterization of future behavior.

This interval may also contain variability and correlations, as there can be uncertainty in how long a business can hold off accepting or rejecting a project or service. When this interval is 0, the present invention determines whether to accept or reject the project or service upon its arrival. The objective of the optimization can be any function of economic losses and gains, strategic losses and gains, project or service quality, business effectiveness, business efficiency, innovation, business opportunities, and so on.

The objective of the optimization can be any long-term function of economic losses and gains, strategic losses and gains, project or service quality, business effectiveness, business efficiency, innovation, business opportunities, and so on. Constraints can be provided for any of these variables as well as tolerances on the various workforce management and planning decisions and actions, or these variables and tolerances can be unconstrained.

In the above exemplary embodiment, the present invention generally relates to workforce management and planning of any collection of resources in general. This includes, but is not limited to, human resources or other flexible resources such as multi-purpose devices. In all of the above cases, resources can be simultaneously working on multiple projects or services employing any combination of capabilities, skills or experience.

The risk-based models and optimization for each component of the present invention support interactive what-if, sensitivity and scenario analysis with respect to all elements of the models and solutions, including assumptions and parameters. The risk-based models and optimization also include the uncertainty in a resource completing its role in a project or service and thus becoming available for another project or service.

Further, the risk-based models and optimization also includes decisions about contracting, subcontracting, outsourcing and other non-traditional resource options to meet demand. Constraints can be provided for any model or optimization variables as well as tolerances on loss risk probabilities, key business indicators and performance targets, or these variables and tolerances can be unconstrained.

Somewhat related models have been developed in application areas such as telecommunications. There are significant differences with the present invention due to: the dynamic and flexible behavior of human resources, the ability of human resources to play multiple roles (capabilities, skills, experience) at the same time. Somewhat related methods have been developed in application areas, such as inventory management. There are significant differences with the present invention due to: the ability to halt hiring, retraining, etc. processes at any point prior to completion, the generalization of substitutability and interchangeability that is possible with human resources.

To illustrate the risk-based approach of the present invention, the following workforce planning system can be taken as a non-limiting example. The planning horizon is [0,T]. The resources available can be categorized into I classes, indexed from 1 to I, and let us denote Cᵢ to be the capacity of resource i. These resources correspond to the workforce capacity mentioned above, such as Web sphere specialists, project managers, etc. There are J types of projects indexed as j=1, 2, . . . , J; project of type j requires Aᵢⱼ units of resource i. The arrivals of different project types are independent Poisson processes with rate qⱼ, j=1, . . . , J. Hence, the overall process of project arrivals is a Poisson process with rate q, q=q+q₂+ . . . +q_{J}. The duration of a project type j, say Sⱼ, has distribution function Fⱼ(.). When a project arrives, it is accepted only if there are enough resources that are required; otherwise, the project will be lost.

In the case when the demand process is stationary, the resource capacity levels can be determined by an optimization problem. The goal is to calculate required capacities to satisfy the demand. The fulfillment of the demand is measured by a service level. More specifically, the probability of a certain type of projects being lost due to the lack of resources is called loss risk. Service agreements usually require that the blocking probability of a project type j is less than certain pre-specified level aⱼ.

The optimization formulation for this illustrative example of Demand Capacity Plan (mode II) has the following form:

$$min {\sum }_{i = 1}^{I} {c}_{i} {C}_{i}$$

$$s . t . {\sum }_{i = 1}^{I} {( {B}_{i} - B ( {η}_{i} , {C}_{i} ) )}^{2} = 0$$

$$1 - {\prod }_{i} {( 1 - {B}_{i} )}^{{A}_{ij}} \leq {a}_{j} ,$$

where B(α, x)=(α^{-x}e^{α(x+}1,α))⁻¹, and

$${η}_{i} = {( 1 - {B}_{i} )}^{- 1} {\sum }_{j} {A}_{ij} {ρ}_{j} {\prod }_{k} {( 1 - {B}_{k} )}^{{A}_{kj}} .$$

The parameters cᵢ, i=1, 2, . . . , I, represent weights assigned to resources i=1, 2, 3, . . . I, which can reflect, among other things, the cost of obtaining and retaining the resources. The parameters Cᵢ represent the capacities of resource i; Bᵢ represent the probability of insufficient resources of type i; ηᵢ represent the effective demand rate for resources of type i; Aᵢⱼ represent the amount of resources of type i required by a project or service of type j; aⱼ represent the loss risk tolerance. The first constraint is the characterization of the blocking probabilities in the system, and the second reflects the requirements of the service fulfillment (bounds for loss risks). Note that the capacity variables in this illustrative example take on any positive values in the real numbers to represent the diversity and flexibility of resources, although the formulation can also handle positive integer capacity variables.

Similarly, an illustrative example of Demand Capacity Plan (mode I) can be formulated to solve the above problem in the reversed direction. That is, given the resource capacity levels, the loss risks are calculated for each project type. The corresponding optimization is of the similar form. This capability enables a planner to conduct what-if analysis in order to cover other factors in the capacity planning that are usually not easy to be modeled or quantified.

Anyone skilled in the art will understand that the formulas in the above illustrative example can be replaced by formulas from other probabilistic and optimization models. Possible alternatives include other stochastic loss networks, stochastic queueing networks and stochastic programming models. However, the present invention is not limited to these alternatives and can incorporate any probabilistic and optimization models relevant to the Demand Capacity Plan.

A non-limiting illustrative example of the Supply Capacity Plan is demonstrated in the following scenario. Given the forecasted attrition rate fₖ, k=1, 2, . . . , K, for the supply capacities, an optimization problem, similar to the one above, can be used to determine the target attrition rate for each resource type and the degree to which resources can be incented to achieve these target attrition rates. Anyone skilled in the art will understand that the formulas in the above illustrative example can be replaced by formulas from other probabilistic and optimization models. Possible alternatives include other stochastic optimal control models, deterministic optimal control models and stochastic programming. However, the present invention is not limited to these alternatives and can incorporate any probabilistic and optimization models relevant to the Supply Capacity Plan.

The following scenario provides an exemplary illustration of the multi-attribute gap/glut analysis. Given planned capacities dᵢ, i=1, 2, . . . , I, and supply capacities rₖ, k=1, 2, . . . , K, multi-attribute gap/glut analysis is achieved by the following optimization problem:

$$min \{ {\sum }_{i = 1}^{I} {w}_{i}^{ga} {x}_{i}^{ga} + {w}_{i}^{gl} {x}_{i}^{gl} \}$$

$${\sum }_{k = 1}^{K} {z}_{ik} + {x}_{i}^{ga} = {d}_{i} + {x}_{i}^{gl}$$

$${\sum }_{i = 1}^{I} {z}_{ik} = {r}_{k}$$

$$Ax = b ,$$

where the weights wᵢ^{ga}, wᵢ^{gl} can be determined by financial factors such as revenue and costs. The first two constraints reflect the basic relationship that gaps and gluts have to satisfy given the planned capacities dᵢ and supply capacities rₖ. The third constraint is a generic constraint that represents other features that can be incorporated in the problem; these features can include, for example, substitutability of different resources, preferences among different resources, and conflicts among different resources. The decision variables xᵢ^{ga} and xᵢ^{gl} represent the gaps and gluts for resources of type i under the optimal solution. The solution of this optimization can be obtained with standard linear programming solvers.

Anyone skilled in the art will understand that the formulas in the above illustrative example can be replaced by formulas from other probabilistic and optimization models. Possible alternatives include nonlinear programming models, objectives with resource preferences, objectives with resource conflicts and stochastic programming models. However, the present invention is not limited to these alternatives and can incorporate any probabilistic and optimization models relevant to the Multi-Attribute Gap/Glut Analysis.

The components from above provide solutions for a single time period. The Planning Action Support component of the present invention extends these solutions to model and optimize the workforce over a multiple consecutive time periods. Take as an illustrative example, without limitation, the following scenario. Suppose that at any time, we can make hiring, firing or retraining decisions to adjust the capacity of each resource type. Such actions will incur costs, denote them by hᵢ, fᵢ, rᵢ, for unit hiring, firing and retraining cost for resource i. Firing decisions may or may not be executed immediately. On the other hand, hiring and retraining decisions have positive lead times. An illustrative example of the optimization problem is as follows:

$$min {\sum }_{n = 1}^{N} {\sum }_{i = 1}^{I} E [ {c}_{i}^{n} {C}_{i}^{n} + {h}_{i} {H}_{i}^{n} + {f}_{i} {F}_{i}^{n} + {r}_{i} {R}_{i}^{n} ]$$

$$s . t . {\sum }_{i = 1}^{I} {[ {B}_{i}^{n} - B ( {η}_{i} , {C}_{i}^{n} ) ]}^{2} = 0 ;$$

$$1 - {\prod }_{i} {( 1 - {B}_{i}^{n} )}^{{A}_{ij}} \leq {a}_{j} ;$$

$${C}_{j}^{n} \geq {C}_{j , 0}^{n} + {H}_{i}^{n} - {F}_{i}^{n} + {R}_{i}^{n} ;$$

where the superscript n for parameters defined above refers to nth time period. The parameters Hᵢⁿ, Hᵢⁿ, Rᵢⁿ represent the number of people hired, fired and retrained, respectively, during the nth time period, where the corresponding lowercase variable represents the costs associated with the action per resource. During each of these periods, decisions regarding resource capacity, and planning actions, represented here by firing, retraining and hiring, are decided, where the quadruple (Cᵢⁿ, Hᵢⁿ, Fᵢⁿ, Rᵢⁿ) denotes the quantitative description of these decisions. The solution of this optimization can be obtained with standard nonlinear programming solvers.

Anyone skilled in the art will understand that the formulas in the above illustrative example can be replaced by formulas from other probabilistic and optimization models. Possible alternatives include other stochastic dynamic programming models, deterministic dynamic programming models, stochastic programming, stochastic or deterministic optimal control models. However, the present invention is not limited to these alternatives and can incorporate any probabilistic and optimization models relevant to the Planning Action Support component.

Exemplary Hardware Implementation

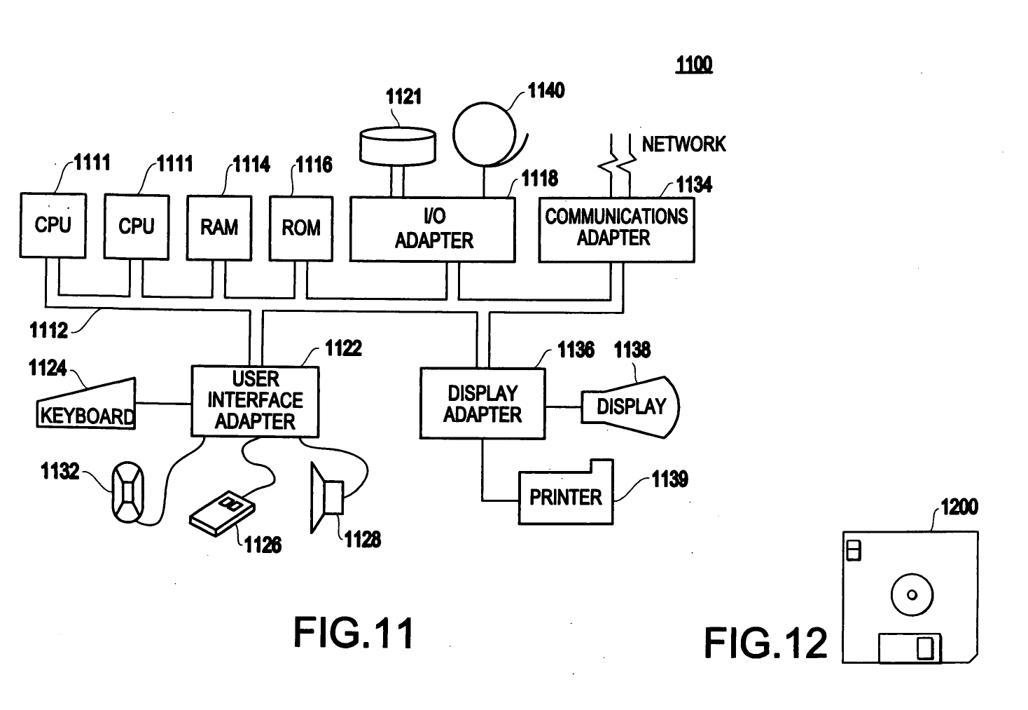

FIG. 11 illustrates a typical hardware configuration of an information handling/computer system in accordance with the invention and which preferably has at least one processor or central processing unit (CPU) 1111.

The CPUs 1111 are interconnected via a system bus 1112 to a random access memory (RAM) 1114, read-only memory (ROM) 1116, input/output (I/O) adapter 1118 (for connecting peripheral devices such as disk units 1121 and tape drives 1140 to the bus 1112), user interface adapter 422 (for connecting a keyboard 1124, mouse 1126, speaker 1128, microphone 1132, and/or other user interface device to the bus 1112), a communication adapter 1134 for connecting an information handling system to a data processing network, the Internet, an Intranet, a personal area network (PAN), etc., and a display adapter 1136 for connecting the bus 1112 to a display device 1138 and/or printer 1139 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 1111 and hardware above, to perform the method of the invention.

This signal-bearing media may include, for example, a RAM contained within the CPU 1111, as represented by the fast-access storage for example. Alternatively, the instructions may be contained in another signal-bearing media, such as a magnetic data storage diskette 1200 (FIG. 12), directly or indirectly accessible by the CPU 1111.

Whether contained in the diskette 1200, the computer/CPU 1111, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

Having thus described our invention, what we claim as new and desire to secure by Letters Patent is as follows:

1. A method of managing resources, comprising:
identifying a project or service opportunity, said project or service opportunity comprising disparate resource attribute requirements;
identifying at least one of internal and external flexible resources suitable for said project or service opportunity; and
correlating the internal and external flexible resources with the disparate resource attribute requirements for managing a risk associated with said project or service opportunity.

2. A method according to claim 1, wherein the risk comprises a probability of losing project or service opportunities due to insufficient resources with the required attributes.

3. A method according to claim 1, wherein the risk comprises a probability of losing at least one project or service opportunity due to insufficient resources with the required attributes.

4. A method according to claim 1, wherein the risk comprises a probability of losing project or service opportunities across a set of said opportunities over a time horizon.

5. A method according to claim 1, wherein the flexible resources comprise human resources.

6. A method of managing a collection of resources, said method comprising:
calculating a stochastic model of a demand; and
calculating a stochastic model of a supply of resource to meet said demand.

7. The method of claim 6, wherein said demand model and said supply model comprise models based on a recurring period of time.

8. The method of claim 6, further comprising:
determining a potential gap/glut between said demand model and said supply model.

9. The method of claim 6, wherein said collection of resources includes elements of a workforce.

10. The method of claim 6, further comprising:
an optimization of at least one of said demand model and said supply model.

11. The method of claim 10, wherein said optimization of said demand model comprises an optimization of:
$$min {\sum }_{i = 1}^{I} {c}_{i} {C}_{i}$$
$$s . t . {\sum }_{i = 1}^{I} {( {B}_{i} - B ( {η}_{i} , {C}_{i} ) )}^{2} = 0$$
$$1 - {\prod }_{i} {( 1 - {B}_{i} )}^{{A}_{ij}} \leq {a}_{j} ,$$
wherein B(α,x)=(αa^{-x}e^{α}Γ(x+1,α))⁻¹, and
$${η}_{i} = {( 1 - {B}_{i} )}^{- 1} {\sum }_{j} {A}_{ij} {ρ}_{j} {\prod }_{k} {( 1 - {B}_{k} )}^{{A}_{kj}} ,$$
parameters cᵢ, i=1, 2, . . . , I, represent weights assigned to resources i=1, 2, 3, . . . I, which can reflect, among other things, a cost of obtaining and retaining the resources, parameters Cᵢ represent capacities of resource i, Bᵢ represent a probability of insufficient resources of type i, ηᵢ represent an effective demand rate for resources of type i, Aᵢⱼ represent an amount of resources of a type i required by a project or service of type j, and aⱼ represent a loss risk tolerance.

12. The method of claim 8, wherein said potential gap/glut is determined by:
given planned capacities dᵢ, i=1, 2, . . . , I, and supply capacities rₖ, k=1, 2, . . . , K, a multi-attribute gap/glut analysis is achieved by an optimization problem, as follows:
$$min \{ {\sum }_{i = 1}^{I} {w}_{i}^{ga} {x}_{i}^{ga} + {w}_{i}^{gl} {x}_{i}^{gl} \}$$
$${\sum }_{k = 1}^{K} {z}_{ik} + {x}_{i}^{ga} = {d}_{i} + {x}_{i}^{gl}$$
$${\sum }_{i = 1}^{I} {z}_{ik} = {r}_{k}$$
$$Ax = b ,$$
where weights wᵢ^{ga}, Wᵢ^{gl} is determined by financial factors such as revenue and costs, a first two constraints above reflect a basic relationship that gaps and gluts have to satisfy, given planned capacities dᵢ and supply capacities rₖ, a third constraint above comprises a generic constraint that represents other features that can be incorporated, such as substitutability of different resources, preferences among different resources, and conflicts among different resources, and decision variables xᵢ^{ga} and xᵢ^{gl} represent gaps and gluts for resources of a type i under an optimal solution.

13. The method of claim 9, wherein hiring, firing or retraining decisions are used to adjust the capacity of each resource type, such actions incurring costs denoted them by hᵢ, fᵢ, rᵢ, for unit hiring, firing and retraining cost for resource i, hiring and retraining decisions have positive lead times, and said capacity is adjusted by an optimization problem, as follows:
$$min {\sum }_{n = 1}^{N} {\sum }_{i = 1}^{I} E [ {c}_{i}^{n} {C}_{i}^{n} + {h}_{i} {H}_{i}^{n} + {f}_{i} {F}_{i}^{n} + {r}_{i} {R}_{i}^{n} ]$$
$$s . t . {\sum }_{i = 1}^{I} {[ {B}_{i}^{n} - B ( {η}_{i} , {C}_{i}^{n} ) ]}^{2} = 0 ;$$
$$1 - {\prod }_{i} {( 1 - {B}_{i}^{n} )}^{{A}_{ij}} \leq {a}_{j} ;$$
$${C}_{j}^{n} \geq {C}_{j , 0}^{n} + {H}_{i}^{n} - {F}_{i}^{n} + {R}_{i}^{n} ;$$
wherein superscript n for parameters defined above refers to an nth time period, parameters Hᵢⁿ, Fᵢⁿ, Rᵢⁿ represent a number of people hired, fired and retrained, respectively, during the nth time period, wherein corresponding lowercase variable represents costs associated with action per resource, during each of these periods, decisions regarding resource capacity, and planning actions, represented by firing, retraining and hiring, are decided, where a quadruple (Cᵢⁿ, Hᵢⁿ, Fᵢⁿ, Rᵢⁿ) denotes a quantitative description of these decisions.

14. A signal-bearing medium tangibly embodying a program of machine-readable instructions executable by a digital processing apparatus to perform a method of managing a collection of resources, said method comprising:
calculating a stochastic model of a demand; and
calculating a stochastic model of a supply of resource to meet said demand.

15. The method of claim 14, further comprising:
determining a potential gap/glut between said demand model and said supply model.

16. The method of claim 14, wherein said collection of resources includes elements of a workforce and said demand model and said supply model comprise models based on a recurring period of time.

17. The method of claim 14, further comprising:
an optimization of at least one of said demand model and said supply model.

18. The method of claim 16, wherein said potential gap/glut is determined by:
given planned capacities dᵢ, i=1, 2, . . . , I, and supply capacities rₖ, k=1, 2, . . . , K, a multi-attribute gap/glut analysis is achieved by an optimization problem, as follows:
$$min \{ {\sum }_{i = 1}^{I} {w}_{i}^{ga} {x}_{i}^{ga} + {w}_{i}^{gl} {x}_{i}^{gl} \}$$
$${\sum }_{k = 1}^{K} {z}_{ik} + {x}_{i}^{ga} = {d}_{i} + {x}_{i}^{gl}$$
$${\sum }_{i = 1}^{I} {z}_{ik} = {r}_{k}$$
$$Ax = b ,$$
where weights wᵢ^{ga}, wᵢ^{gl} is determined by financial factors such as revenue and costs, a first two constraints above reflect a basic relationship that gaps and gluts have to satisfy, given planned capacities dᵢ and supply capacities rₖ., a third constraint above comprises a generic constraint that represents other features that can be incorporated, such as substitutability of different resources, preferences among different resources, and conflicts among different resources, and decision variables xᵢ^{ga} and xᵢ^{gl} represent gaps and gluts for resources of a type i under an optimal solution.

19. The method of claim 16, wherein hiring, firing or retraining decisions are used to adjust the capacity of each resource type, such actions incurring costs denoted them by hᵢ, fᵢ, rᵢ, for unit hiring, firing and retraining cost for resource i, hiring and retraining decisions have positive lead times, and said capacity is adjusted by an optimization problem, as follows:
$$min {\sum }_{n = 1}^{N} {\sum }_{i = 1}^{I} E [ {c}_{i}^{n} {C}_{i}^{n} + {h}_{i} {H}_{i}^{n} + {f}_{i} {F}_{i}^{n} + {r}_{i} {R}_{i}^{n} ]$$
$$s . t . {\sum }_{i = 1}^{I} {[ {B}_{i}^{n} - B ( {η}_{i} , {C}_{i}^{n} ) ]}^{2} = 0 ;$$
$$1 - {\prod }_{i} {( 1 - {B}_{i}^{n} )}^{{A}_{ij}} \leq {a}_{j} ;$$
$${C}_{j}^{n} \geq {C}_{j , 0}^{n} + {H}_{i}^{n} - {F}_{i}^{n} + {R}_{i}^{n} ;$$
wherein superscript n for parameters defined above refers to an nth time period, parameters Hᵢⁿ, Fᵢⁿ, Rᵢⁿ represent a number of people hired, fired and retrained, respectively, during the nth time period, wherein corresponding lowercase variable represents costs associated with action per resource, during each of these periods, decisions regarding resource capacity, and planning actions, represented by firing, retraining and hiring, are decided, where a quadruple (Cᵢⁿ, Hᵢⁿ, Fᵢⁿ, Rᵢⁿ) denotes a quantitative description of these decisions.

20. The signal-bearing medium of claim 17, wherein said optimization of said demand model comprises an optimization of:
$$min {\sum }_{i = 1}^{l} {c}_{i} {C}_{i}$$
$$s . t . {\sum }_{i = 1}^{l} {( {B}_{i} - B ( {η}_{i} , {C}_{i} ) )}^{2} = 0$$
$$1 - {\prod }_{i} {( 1 - {B}_{i} )}^{{A}_{ij}} \leq {a}_{j} ,$$
wherein B(α, x)=(α^{-x}e^{α}Γ(x+1, α))⁻¹, and
$${η}_{i} = {( 1 - {B}_{i} )}^{- 1} {\sum }_{j} {A}_{ij} {ρ}_{j} {\prod }_{k} {( 1 - {B}_{k} )}^{{A}_{kj}} ,$$
parameters cᵢ,i=1, 2, . . . , I, represent weights assigned to resources i=1, 2, 3, . . . I, which can reflect, a cost of obtaining and retaining the resources, parameters Cᵢ represent capacities of resource i, Bᵢ represent a probability of insufficient resources of type i, ηᵢ represent an effective demand rate for resources of type i, Aᵢⱼ represent an amount of resources of a type i required by a project or service of type j, and aⱼ represent a loss risk tolerance.
